(19) United States
(12) Patent Application Publication
(10) Pub. No.: US 2025/0039417 A1
(43) Pub. Date: Jan. 30, 2025

(54) CONTEXT AND BYPASS CODING VIDEO

(71) Applicant: Texas Instruments Incorporated, Dallas, TX (US)

(72) Inventors: Madhukar Budagavi, Plano, TX (US); Mehmet U. Demircin, Dallas, TX (US); Vivienne Sze, Cambridge, MA (US)

(21) Appl. No.: 18/911,329

(22) Filed: Oct. 10, 2024

Related U.S. Application Data
(63) Continuation of application No. 18/241,316, filed on Sep. 1, 2023, now Pat. No. 12,120,333.
Application No. 18/241,316 is a continuation of application No. 17/936,003, filed on Sep. 28, 2022, now Pat. No. 11,750,826.
Application No. 17/936,003 is a continuation of application No. 16/518,407, filed on Jul. 22, 2019, now Pat. No. 11,490,103.
Application No. 16/518,407 is a continuation of application No. 15/295,689, filed on Oct. 17, 2016, now Pat. No. 10,362,322.
Application No. 15/295,689 is a continuation of application No. 13/184,226, filed on Jul. 15, 2011, now Pat. No. 9,591,320.
(60) Provisional application No. 61/499,852, filed on Jun. 22, 2011.
(60) Provisional application No. 61/364,593, filed on Jul. 15, 2010.

(51) Int. Cl. H04N 19/436; H04N 19/13; H04N 19/139; H04N 19/176; H04N 19/46; H04N 19/70; H04N 19/91

(52) U.S. Cl. CPC H04N 19/436; H04N 19/13; H04N 19/139; H04N 19/176; H04N 19/46; H04N 19/70; H04N 19/91

(57) ABSTRACT

A method and apparatus for parallel context processing for example for high coding efficient entropy coding in HEVC. The method comprising retrieving syntax element relating to a block of an image, grouping at least two bins belonging to similar context based on the syntax element, and coding the grouped bins in parallel.

### CROSS-REFERENCE TO RELATED APPLICATIONS

This application is a continuation of U.S. application Ser. No. 18/241,316, filed Sep. 1, 2023, currently pending and scheduled to grant as U.S. Pat. No. 12,120,333 on Oct. 15, 2024, which is a continuation of U.S. application Ser. No. 17/936,003, filed Sep. 28, 2022 (now U.S. Pat. No. 11,750,826), which is a continuation of U.S. application Ser. No. 16/518,407, filed Jul. 22, 2019 (now U.S. Pat. No. 11,490,103), which is a continuation of U.S. application Ser. No. 15/295,689, filed Oct. 17, 2016 (now U.S. Pat. No. 10,362,322), which is a continuation of U.S. application Ser. No. 13/184,226, filed Jul. 15, 2011 (now U.S. Pat. No. 9,591,320), which claims the benefit of U.S. Provisional Application No. 61/499,852, filed Jun. 22, 2011, and claims the benefit of U.S. Provisional Application No. 61/364,593, filed Jul. 15, 2010, the entireties of all of which are hereby incorporated by reference. This application is related to U.S. application Ser. No. 16/891,353, filed Jun. 3, 2020 (now U.S. Pat. No. 10,939,131).

### BACKGROUND OF THE INVENTION

### Field of the Invention

Embodiments of the present invention generally relate to a method and apparatus for parallel context processing techniques for high coding efficiency entropy coding, which may be used in the video coding standard High Efficiency Video Coding (HEVC).

### Description of the Related Art

Context-Adaptive Binary Arithmetic Coding (CABAC) is one of two entropy engines used by the existing video coding standard AVC. CABAC is a method of entropy coding that provides high coding efficiency. Processing in CABAC engine is highly serial in nature. Consequently, in order to decode high bit rate video bit-streams in real-time, the CABAC engine needs to be run at extremely high frequencies which consumes a significant amount of power and in the worst case may not be feasible.

Therefore, there is a need for an improved method and/or apparatus for parallel context processing techniques for high coding efficiency entropy coding in HEVC.

### SUMMARY OF THE INVENTION

Embodiments of the present invention relate to a method and apparatus for parallel context processing for example for high coding efficient entropy coding, such as, HEVC. The method comprising retrieving syntax element relating to a block of an image, grouping at least two bins belonging to similar context based on the syntax element, and coding the grouped bins in parallel.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of a CABAC block diagram;

FIG. 2 is an embodiment of a flow diagram depicting PIPE/V2V coding;

FIG. 3 is an embodiment of a syntax element partitioning;

FIG. 4A is an embodiment of a flow diagram depicting a parallelization of context processing for significance map utilizing speculative computing at each bin;

FIG. 4B is an embodiment of a flow diagram depicting a parallelization of context processing for significance map utilizing speculative computing at a fifth bin;

FIG. 5 is an embodiment of a flow diagram depicting a method for context processing tree for level coding in AVC;

FIG. 6 is an embodiment of a flow diagram depicting context processing tree for levels when SIGN is coded in separate bin-plane; and

FIG. 7 is an embodiment of a proposed approach on order of syntax elements.

### DETAILED DESCRIPTION

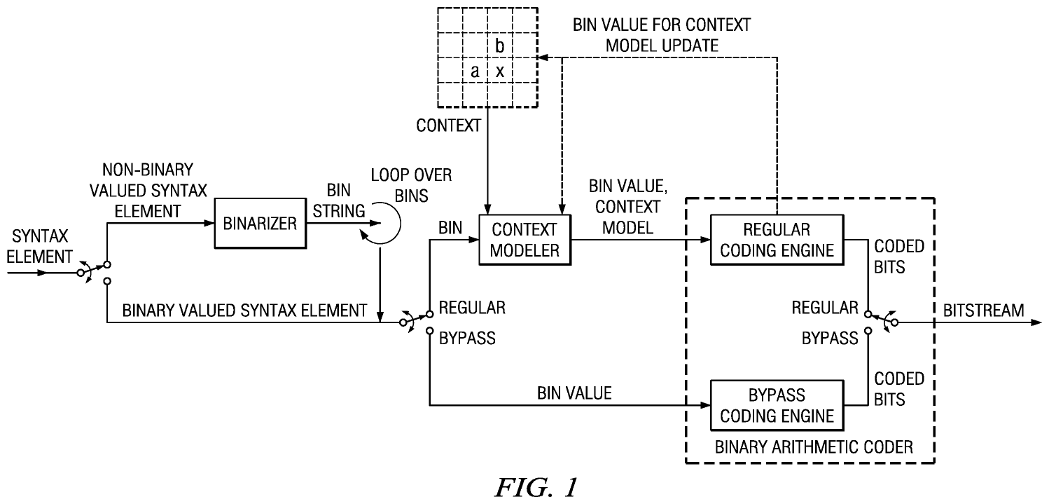

FIG. 1 is an embodiment of a CABAC block diagram. As shown in FIG. 1, the serial nature in CABAC comes from the following three blocks, a binarizer, a context modeler and a binary arithmetic coder. In the binarizer, bins from many syntax elements, such as, coefficient levels and motion vector differences are coded using variable length coding such as unary coding and exp-Golomb coding. Variable length codes are inherently serial in nature. In the context modeler, the serial dependency comes about since the probability used in the context model for coding the next bin is updated depending on the current bin value. If the current bin value is Least Probable Symbol (LPS), the probability is increased and if the current bin value is Most Probable Symbol (MPS), the probability is decreased. Another source of serial dependency is the context index selection process, where the context index of bin may be determined by the value of previously coded bins. In the binary arithmetic coder (BAC), the arithmetic coding uses interval subdivision. The range, value, offset used to determine the interval on [0, 1] that uniquely identifies the coded stream of bin values are updated in a serial fashion as and when bins get encoded/decoded.

In some embodiments of parallel entropy coding tools, the parallelism proposed may be broadly classified into three categories: (1) Bin-level parallelism, which parallelizes the BAC, (2) Syntax element-level parallelism, which parallelizes the BAC, the context modeler, and the binarizer and (3) Slice-level parallelism.

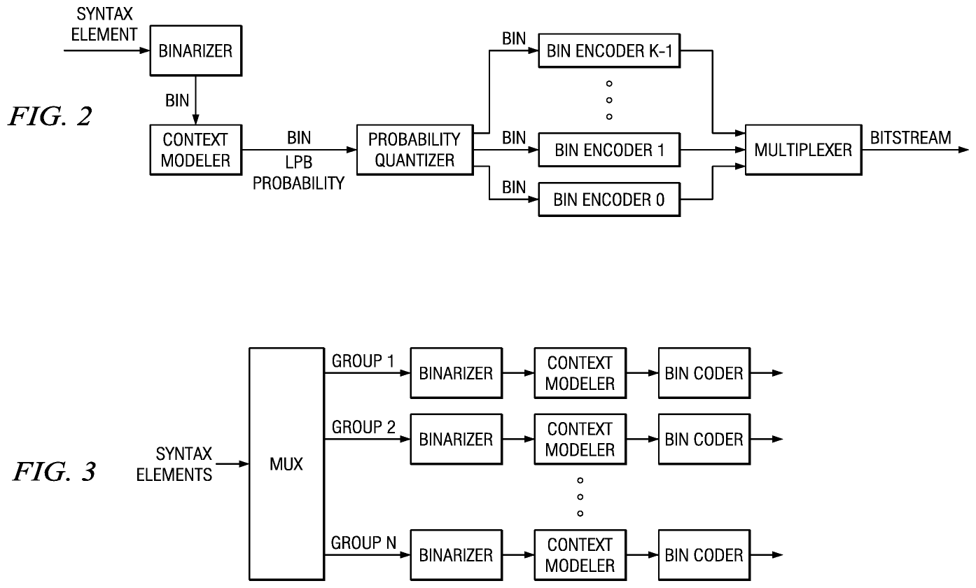

A N-bins/cycle coding (NBAC) encodes and decodes N-bins/cycle to achieve N-fold improvement in throughput. The contexts for N-bins are calculated through the use of conditional probabilities. In some HEVC embodiment, the binarizer and context modeler were basically the same as in CABAC of AVC. However, coding schemes are determined variable-to-variable length for coding of the bins. There are two flavors of the scheme: (1) PIPE and (2) V2V. The main difference between the two is the context probabilities are quantized to 12 levels in PIPE and to 64 in V2V. In PIPE/V2V coding scheme, the bins are coded using a parallel bin encoding scheme as shown in FIG. 2. FIG. 2 is an embodiment of a flow diagram depicting PIPE/V2V coding.

Some embodiments that utilize schemes that interleaves the V2V code words from different partial bitstreams into a single bitstream. As a result, a throughput increase of 6X for PIPE in hardware is possible. Such embodiments usually cause an estimated throughput increase of 3X in BAC stage for PIPE hardware implementation for both the parallel and serial versions of PIPE. Since PIPE uses 12 bitstream buffers and V2V uses 64 bitstream buffers, PIPE is usually utilized more often than V2V from a complexity purpose. However in both cases, there is no estimated overall throughput improvement in the entropy coder due to serial bottlenecks in context processing and binarization.

The NBAC, PIPE, V2V schemes reduces serial dependency in the BAC block. However, the serial dependency in the context modeler and binarizer still remain. So, the effective throughput increase that can be achieved in entropy coding is limited. Hence, techniques for parallelization of context processing (PCP) may be utilized.

In syntax element partitioning, syntax elements such as macroblock type, motion vectors, transform coefficients, significant coefficient map etc. are divided into N groups and each group is coded separately. The context selection and adaptation within a group happens in parallel leading to a potential N-fold speed up in context modeler if the various partitions are balanced in terms of the number of bins they process. In practice, the various partitions are not balanced and the throughput improvement is less than a factor of N.

FIG. 3 is an embodiment of a syntax element partitioning. FIG. 3 shows the block diagram of a system with N syntax partitions. The bin coders can be arithmetic coders or PIPE/V2V coders. If PIPE/V2V coders are used as the bin coders, the serial version of PIPE interleaving codewords maybe preferable for reducing the number of bitstream buffers.

Syntax element partitioning results showed throughput improvement and BD-Rate. In this embodiment, significance map coding is carried out in AVC CABAC. In such an embodiment, the last significant coefficient flag is transmitted when the related coefficient is determined to be significant. The coefficient is the output of a block after transform and quantization. Also, a coefficient is significant when it has value that is non-zero.

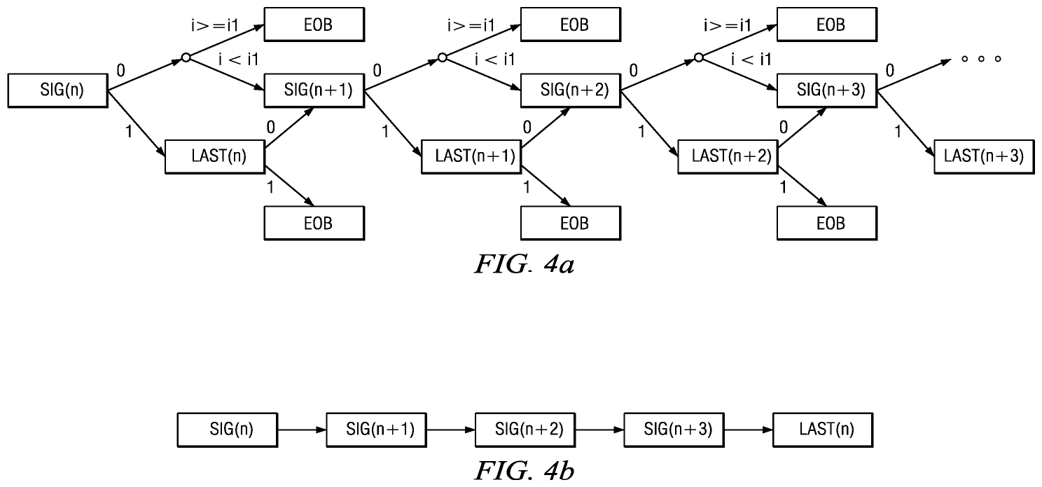

This technique introduces serial dependency in decoding of significance map. When throughput improvement is needed, speculative computation are performed at every bin. Such computations leads to complex logic, as shown in FIG. 4A. FIG. 4A is an embodiment of a flow diagram depicting a parallelization of context processing for significance map utilizing speculative computing at each bin. Speculative computation at every bin also results in increased power consumption.

Significance map coding are parallelized by transmitting the last significant coefficient flag once per certain number of bins. For example, FIG. 4B is an embodiment of a flow diagram depicting a parallelization of context processing for significance map utilizing speculative computing at a fifth bin. If all of the significant coefficient flag is zero, then the last significant coefficient flag is not transmitted.

Such an embodiment reduces the number of last bins that need to be transmitted, but it increases the number of significant bins that need to be transmitted. However, there is about a 5% overall reduction in the number of significance map bins that need to be processed. Our algorithm parallelizes about 21.65% of the bins for largest coding unit (LCTB).

Table 1 shows the distribution of bins used by different syntax element types as a percent of total bins for a LCTB. The bin distribution was obtained by measuring bins in bitstreams generated, for example, by TMuC-0.1 using cfg files in cfp-fast directory. Shown in Table 1 is the distribution of bins used by different syntax element type as a percent of total bins for an LCU.

TABLE 1

| Bins used per syntax | Average number of bins |
|---|---|
| SigMap | 21.65% |
| SigLast | 8.35% |
| LevelAbs | 16.67% |
| LevelSign | 9.92% |

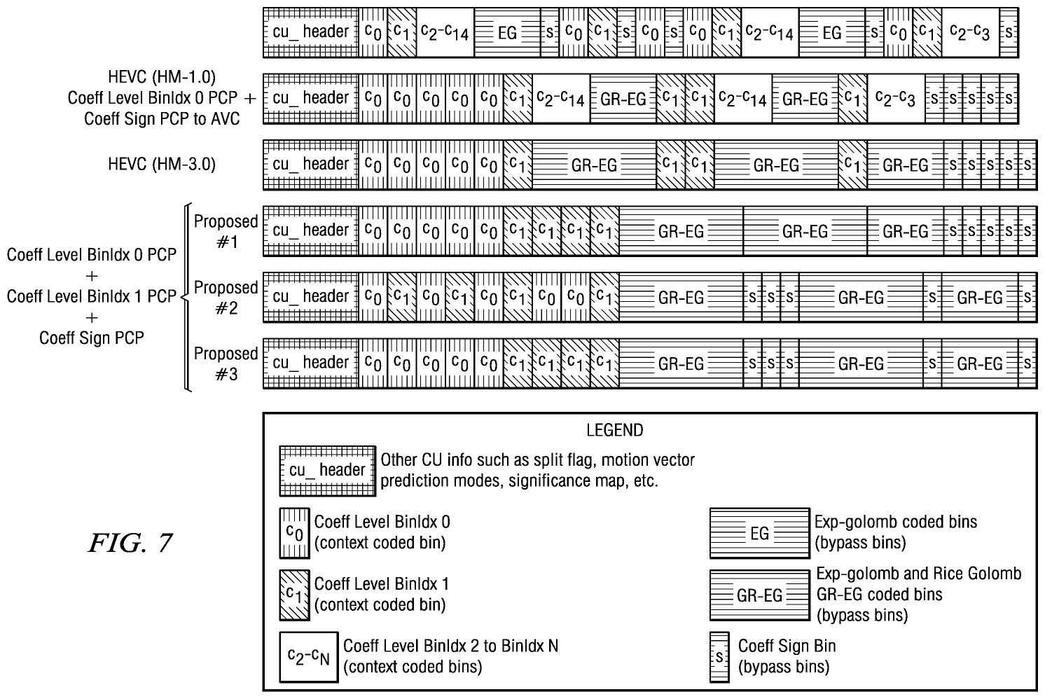

The coefficient coding is usually carried out in AVC CABAC. The context used for the absolute value of the coefficient minus one, known as the coefficient level (1) depends on the position of the bin. Thus, when the binIdx is 0 (i.e. first bin of the coefficient level), then the context is derived by (ctxIdxInc=((numDecodAbsLevelGt1!=0)? 0: Min (4, 1+numDecodAbsLevelEq1))); Otherwise, context is divided by (ctxldxInc=5+Min (4 ((ctxBlockCat==3)? 1:0), numDecodAbsLevelGt1)). Context processing for the first bin in the absolute value of the coefficient minus one (i.e. Coeff Level Binldx 0 in FIG. 7) is different from the other bins in the coefficient level.

In one embodiment, the encoding Coeff Level Binldx 0 occurs in a separate bin-plane as shown in the second row of FIG. 7. The advantage in the context processing, because it can be carried out in parallel to the rest of the context processing i.e. the context processing for all the Coeff Level Binldx 0, for all the coefficients level in a block, may be carried out in parallel to bin processing of Coeff Level Binldx 0 before the decoding of the other bins in the coefficient level. This is referred to as Coeff Level Binldx PCP.

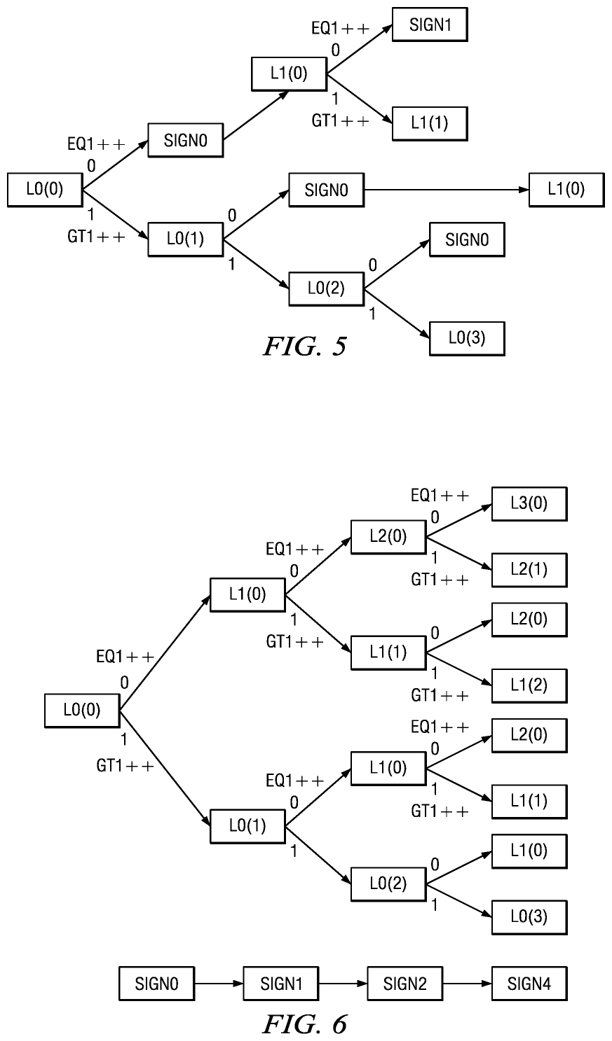

In AVC, sign information is interleaved along with level information as shown in FIG. 5. This leads to inefficiency in parallel context processing. FIG. 5 is an embodiment of a flow diagram depicting a method for context processing tree for level coding in AVC. In FIG. 5, the context processing tree that needs to be pre-calculated at each bin to achieve 4X parallelism in context processing of level in AVC. The context processing that happens at every SIGN node is wasteful since SIGN is coded in bypass mode. Table 2 shows the distribution of level of coefficients obtained by measuring levels in bitstreams generated by, for example, a TMuC-0.1 using cfg files in cfp-fast directory.

TABLE 2

| Level | Probability of occurrence |
|---|---|
| 1 | 0.76 |
| 2 | 0.15 |
| 3 | 0.05 |
| 4 | 0.02 |
| 5 | 0.01 |

Level=1 occurs with the highest probability, so the most probable path in the context processing tree of FIG. 6 is L0(0) [symbol] SIGN0 [symbol] L1(0) [symbol] SIGN1. For this particular path, the context processing efficiency is 50%, meaning half the context processing is wasteful. On the average, for the context processing tree of FIG. 6 and assuming the level distribution of Table 3, the context processing efficiency is 60%. FIG. 6 is an embodiment of a flow diagram depicting context processing tree for levels when SIGN is coded in separate bin-plane. In FIG. 6, the context processing tree for levels when sign is coded in separate bin-plane. As can be seen in the figure, context processing efficiency is 100%. This is also illustrated in FIG. 7 where all sign bins (i.e. Coeff Sign Bins) are coded on separate bin plans; this is referred to as Coeff Sign PCP.

In some embodiment, the first two bins in the coefficient level are context coded. The rest of the bins, such as, coefficient sign bins and Golomb-Rice+Exp-Golomb (GR-EG) binarized bins, are bypass coded. As an extension of “Coeff Level Binldx 0 PCP”, the second bin in the absolute value of the coefficient minus 1 (i.e. Coeff Level Binldx 1) is also coded in a separate bin-plane. The Coeff Sign Level can be interleaved or be on a separate bin-plane with GR-EG bins.

FIG. 7 is an embodiment of a proposed approach on order of syntax elements. FIG. 7 illustrates a data ordering based on Coeff Level Binldx 0 PCP, Coefficient Sign PCP, and Coeff Level Binldx 1 PCP. Bypass coded bins are Coefficient Sign & GR-EG bins. The first row shows original ordering used in H.264/AVC. The ordering of HEVC (HM-1.0), in which the proposed Coeff Level Binldx 0 PCP and Coefficient Sign PCP was adopted, is shown in the second row. Here c0 and sign can be placed in partitions that can be coded in parallel with the other bins. The new coefficient level binarization and coding introduced in HM-3.0 is shown in the third row. Finally, the proposed Coeff Level Binldx 1 PCP is shown in the fourth row. Here c0, c1 and sign+GR-EG bins can be placed in partitions that can be coded in parallel with the other bins. Note that sign and GR-EG bins (i.e. exp-golomb and golomb rice bins of coeff) can be placed in the same partition as all are bypass coded.

Since bypass coding is simpler than context coding, bypass bins can be coded faster than context coded bins. In particular, many bypass bins can be coded in a cycle which can increase the throughput of the CABAC. With Coeff Level Binldx 1 PCP all bypass coded bins for coefficients in a given TU are grouped together which increases throughput impact of parallel bypass bins processing.

Variants of this approach include separating GR-EG+sign bins from the Coeff Level Binldx 0 and Coeff Level Binldx 1, but keeping the GR-EG+sign bins interleaved and keeping the Coeff Level Binldx 0 and Coeff Level Binldx 1 bins interleaved as shown in proposal #2 in FIG. 11. This eliminates the additional of loops required to separate the Coeff Level Binldx 0 from Coeff Level Binldx 1, and Coefficient Sign from RG-EG bins. Alternatively, proposal #3 in FIG. 7 keeps GR-EG and Coefficient sign bins interleaved, to reduce the loops, and keeps Coeff Level Binldx 0 and Coeff Level Binldx 1 in separate partitions. This is due to the fact that the context selection for Coeff Level Binldx 0 and Coeff Level Binldx 1 are more complex and keeping the two separate helps to improve parallel processing as described in section Coeff Level Binldx 0 PCP. This approach can also be applied to other type of syntax elements such as motion vector difference. The bypass bins of the motion vectors difference can be coded together on a separate bin-plane than the context coded bins.

While the foregoing is directed to embodiments of the present invention, other and further embodiments of the invention may be devised without departing from the basic scope thereof, and the scope thereof is determined by the claims that follow.

1. A system comprising:
a memory; and
an encoder coupled to the memory and configured to:
encode a first syntax element into a bit stream, wherein the first syntax element relates to an absolute value of a first transform coefficient;
encode a second syntax element into the bit stream after encoding the first syntax element, wherein the second syntax element relates to an absolute value of a second transform coefficient;
encode a third syntax element into the bit stream after encoding the second syntax element, wherein the third syntax element relates to a sign of the first transform coefficient; and
encode a fourth syntax element into the bit stream after encoding the third syntax element, wherein the fourth syntax element relates to a sign of the second transform coefficient.

2. The system of claim 1, wherein the encoder is configured to:
encode a fifth syntax element after encoding the second syntax element and before encoding the third syntax element, wherein the third syntax element relates to an absolute value of a third transform coefficient; and
encode a sixth syntax element after encoding the fourth syntax element, wherein the sixth syntax element relates to a sign of the third transform coefficient.

3. The system of claim 2, wherein the encoder is configured to:
encode the fifth syntax element using context decoding; and
encode the sixth syntax element using bypass decoding.

4. The system of claim 2,
wherein the first transform coefficient is a first significant transform coefficient within a transform unit of an image,
wherein the second transform coefficient is a second significant transform coefficient within the transform unit, and
wherein the third transform coefficient is a third significant transform coefficient within the transform unit.

5. The system of claim 1,
wherein the first transform coefficient is a first significant transform coefficient within a transform unit of an image, and
wherein the second transform coefficient is a second significant transform coefficient within the transform unit.

6. The system of claim 1, wherein the encoder is configured to:
encode the first syntax element using context decoding; and
encode the second syntax element using context decoding.

7. The system of claim 1, wherein the encoder is configured to:
encode the third syntax element using bypass decoding; and
encode the fourth syntax element using bypass decoding.

8. A method comprising:
encoding a first syntax element into a bit stream, wherein the first syntax element relates to an absolute value of a first transform coefficient;
encoding a second syntax element into the bit stream after encoding the first syntax element, wherein the second syntax element relates to an absolute value of a second transform coefficient;
encoding a third syntax element into the bit stream after encoding the second syntax element, wherein the third syntax element relates to a sign of the first transform coefficient; and
encoding a fourth syntax element into the bit stream after encoding the third syntax element, wherein the fourth syntax element relates to a sign of the second transform coefficient.

9. The method of claim 8, further comprising:
encoding a fifth syntax element after encoding the second syntax element and before encoding the third syntax element, wherein the third syntax element relates to an absolute value of a third transform coefficient;
encoding a sixth syntax element after encoding the fourth syntax element,
wherein the sixth syntax element relates to a sign of the third transform coefficient.

10. The method of claim 9,
wherein encoding the fifth syntax element uses context decoding, and
wherein encoding the sixth syntax element uses bypass decoding.

11. The method of claim 9,
wherein the first transform coefficient is a first significant transform coefficient within a transform unit of an image,
wherein the second transform coefficient is a second significant transform coefficient within the transform unit, and
wherein the third transform coefficient is a third significant transform coefficient within the transform unit.

12. The method of claim 8,
wherein the first transform coefficient is a first significant transform coefficient within a transform unit of an image, and
wherein the second transform coefficient is a second significant transform coefficient within the transform unit.

13. The method of claim 8,
wherein encoding the first syntax element uses context decoding, and
wherein encoding the second syntax element uses context decoding.

14. The method of claim 8,
wherein encoding the third syntax element uses bypass decoding, and
wherein encoding the fourth syntax element uses bypass decoding.

15. A system comprising:
a memory; and
an encoder coupled to the memory and configured to:
encode a first syntax element into a first position in a bit stream, wherein the first syntax element relates to an absolute value of a first transform coefficient;
encode a second syntax element into a second position in the bit stream after the first position in the bit stream, wherein the second syntax element relates to an absolute value of a second transform coefficient;
encode a third syntax element into a third position in the bit stream after the second position in the bit stream, wherein the third syntax element relates to a sign of the first transform coefficient; and
encode a fourth syntax element into a fourth position in the bit stream after the third position in the bit stream, wherein the fourth syntax element relates to a sign of the second transform coefficient.

16. The system of claim 15,
wherein the first transform coefficient is a first significant transform coefficient within a transform unit of an image, and
wherein the second transform coefficient is a second significant transform coefficient within the transform unit.

17. The system of claim 15,
wherein the first transform coefficient is a first significant transform coefficient within a transform unit of an image, and
wherein the second transform coefficient is a second significant transform coefficient within the transform unit.

18. The system of claim 15, wherein the encoder is configured to:
encode the first syntax element using context decoding;
encode the second syntax element using context decoding;
encode the third syntax element using bypass decoding; and
encode the fourth syntax element using bypass decoding.

19. A non-transitory computer-readable medium having a bit stream stored thereon, wherein the bit stream comprises:
a first syntax element relating to an absolute value of a first transform coefficient within a transform unit in an image;
a second syntax element positioned after the first syntax element in the bit stream, wherein the second syntax element relates to an absolute value of a second transform coefficient within the transform unit;
a third syntax element positioned after the second syntax element in the bit stream, wherein the third syntax element relates to a sign of the first transform coefficient; and
a fourth syntax element positioned after the third syntax element in the bit stream, wherein the fourth syntax element relates to a sign of the second transform coefficient.

20. The non-transitory computer-readable medium of claim 19, further comprising:
a fifth syntax element positioned after the second syntax element and before the third syntax element in the bit stream, wherein the third syntax element relates to an absolute value of a third transform coefficient;
a sixth syntax element positioned after the fourth syntax element in the bit stream,
wherein the sixth syntax element relates to a sign of the third transform coefficient.
